(19) United States
(12) Patent Application Publication
(10) Pub. No.: US 2025/0076583 A1
(43) Pub. Date: Mar. 6, 2025

(54) MULTIPLEXER/DEMULTIPLEXER, METHOD OF MANUFACTURING THE SAME, DESIGNING DEVICE, NON-TRANSITORY COMPUTER-READABLE RECORDING MEDIUM, AND DEMULTIPLEXER

(71) Applicants: Sumitomo Electric Industries, Ltd., Osaka (JP); National University Corporation Hokkaido University, Sapporo-shi (JP)

(72) Inventors: Takuya MITARAI, Osaka-shi (JP); Naoki FUJIWARA, Osaka-shi (JP); Takeshi FUJISAWA, Sapporo-shi (JP)

(73) Assignees: Sumitomo Electric Industries, Ltd., Osaka (JP); National University Corporation Hokkaido University, Sapporo-shi (JP)

(21) Appl. No.: 18/805,966

(22) Filed: Aug. 15, 2024

(30) Foreign Application Priority Data
Aug. 29, 2023 (JP) 2023-138976

(51) Int. Cl. G02B 6/293; G02B 27/00

(52) U.S. Cl. CPC G02B 6/2938; G02B 27/0012

(57) ABSTRACT

A method according to the present disclosure is a method of manufacturing a multiplexer/demultiplexer including a substrate, a first port for inputting light, and a second port for outputting light, the first port and the second port being provided in the substrate. The method includes designing positions of a plurality of holes such that three adjacent holes among the plurality of holes are arranged in a triangle lattice, and forming the plurality of holes in a surface of the substrate.

### CROSS REFERENCE TO RELATED APPLICATIONS

This application claims priority based on Japanese Patent Application No. 2023-138976 filed on Aug. 29, 2023, and the entire contents of the Japanese patent application are incorporated herein by reference.

### TECHNICAL FIELD

The present disclosure relates to a multiplexer/demultiplexer, a method of manufacturing the same, a designing device, a non-transitory computer-readable recording medium and a demultiplexer.

### BACKGROUND

Mosaic optical passive elements have been developed. By arranging a plurality of holes in the surface, a small multiplexer/demultiplexer is formed which splits light at a predetermined intensity ratio (see non-patent literature 1: “Compact Power Splitters with Mosaic-based Structure Designed by Bayesian Direct-binary-search Method” Takuya Mitarai et. al. in Proc. OECC/PSS 2022, Toyama, Japan, August 2022, TuE2-4).

### SUMMARY

A method of manufacturing a multiplexer/demultiplexer according to the present disclosure is a method of manufacturing a multiplexer/demultiplexer including a substrate, a first port for inputting light, and a second port for outputting light, the first port and the second port being provided in the substrate. The method includes designing positions of a plurality of holes such that three adjacent holes among the plurality of holes are arranged in a triangle lattice, and forming the plurality of holes in a surface of the substrate.

### BRIEF DESCRIPTION OF THE DRAWINGS

FIG. 1A is a plan view illustrating a multiplexer/demultiplexer according to a first embodiment.

FIG. 1B is an enlarged plan view of the hole.

FIG. 2A is a cross-sectional view illustrating a multiplexer/demultiplexer.

FIG. 2B is a cross-sectional view illustrating a multiplexer/demultiplexer.

FIG. 3A is a block diagram illustrating a designing device of multiplexer/demultiplexer.

FIG. 3B is a block diagram illustrating a hardware configuration of the control unit.

FIG. 3C is a flowchart illustrating a method of manufacturing a multiplexer/demultiplexer.

FIG. 3D is a flowchart illustrating a method of manufacturing a multiplexer/demultiplexer.

FIG. 4 is a plan view illustrating a manufacturing method of a multiplexer/demultiplexer.

FIG. 5A is a cross-sectional view illustrating a manufacturing method of a multiplexer/demultiplexer.

FIG. 5B is a cross-sectional view illustrating a manufacturing method of a multiplexer/demultiplexer.

FIG. 5C is a cross-sectional view illustrating a manufacturing method of a multiplexer/demultiplexer.

FIG. 6 is a diagram illustrating a splitting ratio.

FIG. 7A is an enlarged plan view of the holes in a multiplexer/demultiplexer according to a comparative example.

FIG. 7B is an enlarged plan view of the holes in a multiplexer/demultiplexer for modification.

FIG. 8 is a plan view illustrating a multiplexer/demultiplexer according to a second embodiment.

FIG. 9 is a plan view illustrating a multiplexer/demultiplexer according to a third embodiment.

FIG. 10 is a plan view illustrating a multiplexer/demultiplexer according to a fourth embodiment.

FIG. 11 is a diagram illustrating a splitting ratio.

FIG. 12 is a plan view illustrating a demultiplexer according to a fifth embodiment.

FIG. 13 is a diagram illustrating transmittance.

### DETAILED DESCRIPTION

In the manufacturing process, the holes are formed by designing the arrangement of the holes and performing dry etching on the silicon layer. The wall between the holes may be thinned due to manufacturing errors or the like. The wall may disappear and the holes may be coupled to one. In such a case, the characteristics may be degraded. Thus, it is desirable to provide a multiplexer/demultiplexer, a manufacturing method thereof, a designing device, a non-transitory computer-readable recording medium, and a demultiplexer that are capable of obtaining desired characteristics.

### Description of Embodiments of Present Disclosure

First, the contents of embodiments of the present disclosure will be listed and explained.

(1) A method of manufacturing a multiplexer/demultiplexer according to an aspect of the present disclosure is a method of manufacturing a multiplexer/demultiplexer including a substrate, a first port for inputting light, and a second port for outputting light, the first port and the second port being provided in the substrate. The method includes designing positions of a plurality of holes such that three adjacent holes among the plurality of holes are arranged in a triangle lattice, and forming the plurality of holes in a surface of the substrate. The wall between adjacent holes is thick and is not easily broken. Adjacent holes are not easily coupled to each other and are separated from each other. By providing the designed number and layout of holes, the desired characteristics can be obtained.

(2) In (1), the designing may include dividing the surface of the substrate into a plurality of regions arranged in the triangle lattice, and arranging the holes in some of the plurality of regions, respectively, and arranging no holes in the others of the plurality of regions. The wall becomes thicker and the plurality of holes are separated. The desired characteristics can be obtained.

(3) In (2), the regions may have a regular hexagonal planar shape, and the dividing the surface of the substrate into the plurality of regions may include arranging the plurality of regions in a close-packed structure. The wall becomes thicker and the plurality of holes are separated from each other. The desired characteristics can be obtained.

(4) In any one of (1) to (3), the designing may be designing the positions of the plurality of holes on the basis of characteristics of the multiplexer/demultiplexer. A multiplexer/demultiplexer having a triangle lattice arrangement and desired characteristics can be manufactured.

(5) In any one of (1) to (4), the forming the plurality of holes may include forming the holes by performing dry etching on a silicon layer in the substrate. Since the wall is thick, the plurality of holes are separated from each other. The desired characteristics can be obtained.

(6) In any one of (1) to (5), the method of manufacturing the multiplexer/demultiplexer further may include forming a cladding layer on the surface of the substrate after forming the plurality of holes. This reduces the loss of light.

(7) In (4), the multiplexer/demultiplexer may include a plurality of second ports for outputting light, and the characteristics of the multiplexer/demultiplexer may include a splitting ratio of light to the plurality of second ports.

(8) A multiplexer/demultiplexer includes a substrate, and a first port and a second port provided in the substrate. Light is input to the first port and output from the second port, a plurality of holes are provided in a surface of the substrate, and three adjacent holes among the plurality of holes are arranged in a triangle lattice. The wall between adjacent holes is thick and thus is not easily broken. Adjacent holes are not easily coupled to each other and are separated from each other. By providing the designed number and layout of holes, the desired characteristics can be obtained.

(9) In (8), the substrate may include a silicon layer, and the plurality of holes may be provided in a surface of the silicon layer. Since the wall is thick, the plurality of holes are separated. The desired characteristics can be obtained.

(10) In (8) or (9), the three adjacent holes may be arranged in a regular triangle shape. Since the wall is thick, the plurality of holes are separated from each other. The desired characteristics can be obtained.

(11) In any one of (8) to (10), the first port may include a single port and the second port may include a plurality of ports. The splitting ratio may be set to a desired value.

(12) In any one of (8) to (11), the multiplexer/demultiplexer further may include a cladding layer provided on the surface of the substrate. This reduces the loss of light.

(13) In any one of (8) to (12), the substrate may include a wall between adjacent ones of the plurality of holes, and a thickness of the wall may be 30 nm or more. Adjacent holes are not easily coupled to each other and are separated from each other. The desired characteristics can be obtained.

(14) In (9), the substrate may include the silicon layer and a box layer, and the box layer may be provided on another surface of the silicon layer opposite to the surface of the silicon layer. This reduces the loss of light.

(15) A demultiplexer includes a first multiplexer/demultiplexer, a second multiplexer/demultiplexer, and a third multiplexer/demultiplexer. Each of the first multiplexer/demultiplexer, the second multiplexer/demultiplexer, and the third multiplexer/demultiplexer includes a substrate, and a first port and at least one second port provided in the substrate. A plurality of holes are provided in a surface of the substrate, three adjacent holes among the plurality of holes are arranged in a triangle lattice. The at least one second port of the first multiplexer/demultiplexer includes two second ports. One of the two second ports of the first multiplexer/demultiplexer is coupled to the first port of the second multiplexer/demultiplexer, and the other of the two second ports of the first multiplexer/demultiplexer is coupled to the first port of the third multiplexer/demultiplexer. The desired characteristics can be obtained.

(16) In (15), the substrate of each of the first multiplexer/demultiplexer, the second multiplexer/demultiplexer, and the third multiplexer/demultiplexer may include a silicon layer, and the plurality of holes may be provided in a surface of the silicon layer. Since the wall is thick, the plurality of holes are separated from each other. The desired characteristics can be obtained.

(17) In (15) or (16), in each of the first multiplexer/demultiplexer, the second multiplexer/demultiplexer, and the third multiplexer/demultiplexer, the three adjacent holes may be arranged in a regular triangle shape. Since the wall is thick, the plurality of holes are separated from each other. The desired characteristics can be obtained.

(18) A designing device according to the present disclosure is a designing device for a multiplexer/demultiplexer including a substrate, and a first port for inputting light, a second port for outputting light, and a plurality of holes provided in a surface of the substrate, the first port and the second port being provided on the substrate. The designing device includes a controller that designs positions of the plurality of holes such that three adjacent holes are arranged in a triangle lattice in the surface of the substrate. The wall between adjacent holes is thick and is not easily broken. Adjacent holes are not easily coupled to each other and are separated from each other. By providing the designed number and layout of holes, the desired characteristics can be obtained.

(19) In (18), the controller may include a first design unit that performs design for dividing the surface of the substrate into a plurality of regions arranged in the triangle lattice, and a second design unit that performs design for arranging the holes in some of the plurality of regions, respectively, and arranging no holes in the others of the plurality of regions. Since the wall is thick, the plurality of holes are separated from each other. The desired characteristics can be obtained.

(20) In (19), the regions may have a regular hexagonal planar shape, and the first design unit may arrange the plurality of regions in a close-packed structure on the surface of the substrate. Since the wall is thick, the plurality of holes are separated from each other. The desired characteristics can be obtained.

(21) In any one of (18) to (20), the controller may design the positions of the plurality of holes on the basis of characteristics of the multiplexer/demultiplexer. A multiplexer/demultiplexer having a triangle lattice arrangement and desired characteristics can be manufactured.

(22) A non-transitory computer-readable recording medium according to the present disclosure is a non-transitory computer-readable recording medium having stored therein a designing program for a multiplexer/demultiplexer for causing a computer to execute a process. The multiplexer/demultiplexer includes a substrate, a first port for inputting light, and a second port for outputting light, and a plurality of holes provided in a surface of the substrate, the first port and the second port being provided in the substrate. The process includes designing positions of the plurality of holes such that three adjacent holes among the plurality of holes are arranged in a triangle lattice in the surface of the substrate. The wall between adjacent holes is thick and is not easily broken. Adjacent holes are not easily coupled to each other and are separated from each other. By providing the designed number and layout of holes, the desired characteristics can be obtained.

(23) In (22), the designing positions of the plurality of holes may include performing design for dividing the surface of the substrate into a plurality of regions arranged in the triangle lattice, and performing design for arranging the holes in some of the plurality of regions, respectively, and arranging no holes in the others of the plurality of regions. Since the wall is thick, the plurality of holes are separated from each other. The desired characteristics can be obtained.

(24) In (23), the regions may have a regular hexagonal planar shape, and the plurality of regions may be arranged in a close-packed structure on the surface of the substrate. Since the wall is thick, the plurality of holes are separated from each other. The desired characteristics can be obtained.

(25) In any one of (22) to (24), the designing positions of the plurality of holes may be performed on the basis of characteristics of the multiplexer/demultiplexer. A multiplexer/demultiplexer having a triangle lattice arrangement and desired characteristics can be manufactured.

### Details of Embodiments of Present Disclosure

Specific examples of the multiplexer/demultiplexer, the method of manufacturing the same, the designing device, the designing program, and the demultiplexer according to the embodiments of the present disclosure will be described below with reference to the drawings. The present disclosure is not limited to these illustrative examples, but is defined by the appended claims, and is intended to include all modifications within the scope and meaning equivalent to the appended claims.

### First Embodiment

### (Multiplexer/Demultiplexer)

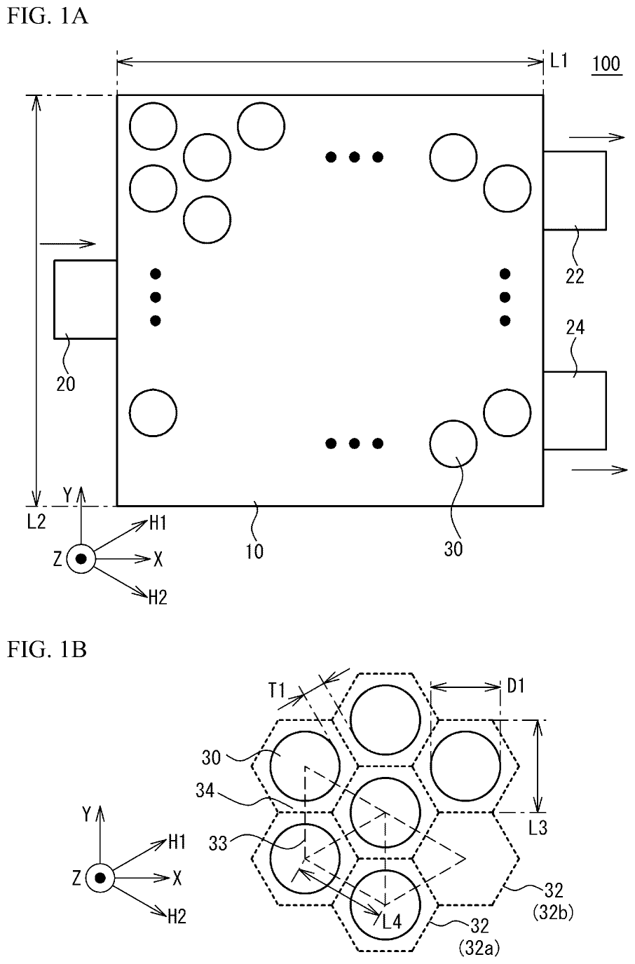

FIG. 1A is a plan view illustrating a multiplexer/demultiplexer 100 according to a first embodiment. The multiplexer/demultiplexer is a mosaic passive optical element. The mosaic pattern means a configuration in which a plurality of holes 30 are two dimensionally arranged in the surface as described later. Multiplexer/demultiplexer 100 splits incident light and output split light, or multiplexes incident plural of light and outputs multiplexed light.

Multiplexer/demultiplexer 100 is formed on a substrate 10. Substrate 10 is, for example, a silicon on insulator (SOI) substrate. The two sides of substrate 10 are parallel to an X-axis direction. The other two sides are parallel to a Y-axis direction. The upper surface of substrate 10 is parallel to an XY plane surface. A Z-axis direction is a normal direction of substrate 10. The X-axis direction, the Y-axis direction, and the Z-axis direction are orthogonal to each other. H1 and H2 axes are parallel to the XY plane surface and are inclined from an X-axis and a Y-axis. The inclination angle of the H1 shaft from the X-axis is, for example, 30°. The inclination angle of the H2 shaft from the X-axis is, for example, −30°.

The planar shape of substrate 10 is a rectangle. A length L1 of a side of substrate 10 in the X-axis direction is, for example, 2.4 μm. A length L2 of a side in the Y-axis direction is, for example, 2.4 μm.

Multiplexer/demultiplexer 100 has a port 20, a port 22, and a port 24. These ports are silicon waveguides formed with a silicon layer 16 described later. The width of the port is, for example, 0.48 μm. Port 20 (first port) functions as, for example, an input port. Port 22 and port 24 (second port) function as, for example, an output port. Port 20 is provided on one side of substrate 10. Port 22 and port 24 are provided on another side of substrate 10.

Multiplexer/demultiplexer 100 has the plurality of holes 30. The plurality of holes 30 are two dimensionally arranged in the surface of substrate 10.

FIG. 1B is an enlarged plan view of hole 30. The plurality of holes 30 and a plurality of regions 32 (pixels) are arranged on the surface of substrate 10. Region 32 (pixel) is set in the design of multiplexer/demultiplexer 100, and region 32 may not be actually manufactured in substrate 10. Hole 30 is formed in substrate 10. The dashed line in FIG. 1B is an imaginary line connecting the centers of regions 32.

The planar shape of hole 30 is, for example, a circle. The planar shape of region 32 is, for example, a regular hexagon. Holes 30 are provided in some of the plurality of regions 32, respectively, and no holes 30 are provided in the others of the plurality of regions 32. Region 32 in which hole 30 is provided is referred to as a region 32a. Region 32 in which no hole 30 is provided is referred to as a region 32b. One hole 30 is located at the center of region 32a. The center of hole 30 coincides with the center of region 32.

The plurality of holes 30 and the plurality of regions 32 are periodically arranged in the directions of the Y-axis, the H1-axis and H2-axis. The plurality of regions 32 are arranged in a close-packed structure. One region 32 is surrounded by six regions 32. Two adjacent regions 32 share one side and share two vertices located at both ends of the side.

A triangle 33 is a virtual equilateral triangle formed by connecting the centers of three regions 32 adjacent to each other. The centers of three regions 32a form triangle 33. Triangle 33 is an equilateral triangle. That is, adjacent holes 30 are arranged in a triangle lattice.

A length L3 between the two opposing sides of region 32 is, for example, 160 nm. Diameter D1 of hole 30 is smaller than the length L3, and is, for example, 120 nm. A distance L4 between the centers of two adjacent holes 30 is, for example, 160 nm. A wall 34 is located between two adjacent holes 30. Wall 34 is thinnest on a line connecting the centers of two adjacent holes 30. A thickness T1 of wall 34 at the thinnest portion is, for example, 40 nm.

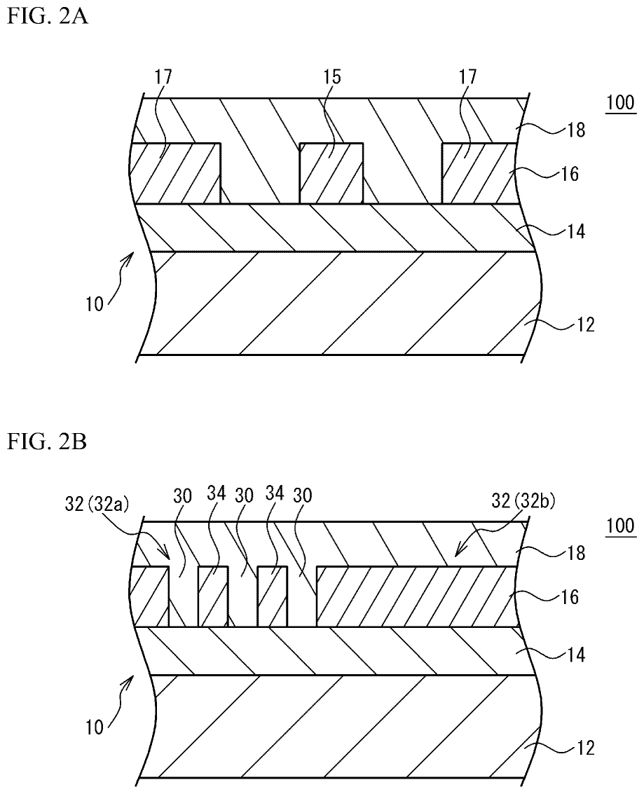

FIG. 2A and FIG. 2B are cross-sectional views illustrating multiplexer/demultiplexer 100. FIG. 2A illustrates a cross-section including port 20. FIG. 2B illustrates a cross-section including hole 30.

As illustrated in FIG. 2A and FIG. 2B, substrate 10 includes a substrate 12, a BOX layer 14, and silicon layer 16. BOX layer 14 is laminated on one surface of substrate 12. Silicon layer 16 is laminated on the surface of BOX layer 14 opposite to substrate 12. A cladding layer 18 is laminated on the surface of silicon layer 16 opposite to BOX layer 14. Substrate 12 and silicon layer 16 are formed of silicon (Si). BOX layer 14 and cladding layer 18 are formed of an insulating material such as silicon oxide (SiO₂). The thickness of BOX layer 14 is, for example, 3 μm. The thickness of silicon layer 16 is, for example, 220 nm.

As illustrated in FIG. 2A, silicon layer 16 has a waveguide core 15 and a terrace 17. Waveguide core 15 functions as port 20. Terrace 17 are located on both sides of waveguide core 15, and waveguide core 15 is spaced apart from terrace 17. In terrace 17, silicon layer 16 forms a flat surface. Cladding layer 18 is embedded between waveguide core 15 and terrace 17. Port 22 and port 24 have the same configuration as port 20.

In FIG. 2B, three holes 30 are provided in silicon layer 16. Hole 30 penetrates silicon layer 16 in the Z-axis direction, but may not penetrate silicon layer 16. The depth of hole 30 can be controlled by the etching time or the like. Hole 30 is filled with cladding layer 18. The refractive index of hole 30 is different from the refractive index of silicon layer 16. Since the refractive index periodically changes in the surface of substrate 10, substrate 10 functions as a photonic crystal. Hole 30 may be a cavity, and air may be trapped therein. Hole 30 is not provided in region 32b of silicon layer 16.

The arrows in FIG. 1A represent the input and output of light. Multiplexer/demultiplexer 100 functions as a one-input-and-two-output demultiplexer. Light is incident on multiplexer/demultiplexer 100 from port 20. The light propagates in the surface of substrate 10 and is emitted from port 22 and port 24. The layout of holes 30 determines a splitting ratio of light. When the splitting ratio is X:Y, X % of the light input from port 20 is output from port 22, and Y (=100−X) % is output from port 24. The arrangement of holes 30 is designed according to the desired splitting ratio.

### (Designing Device)

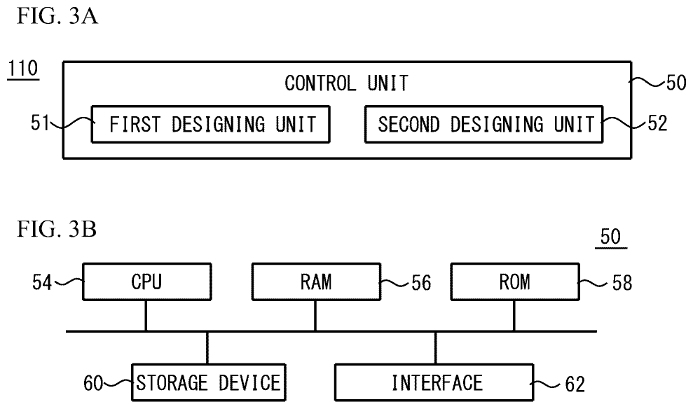

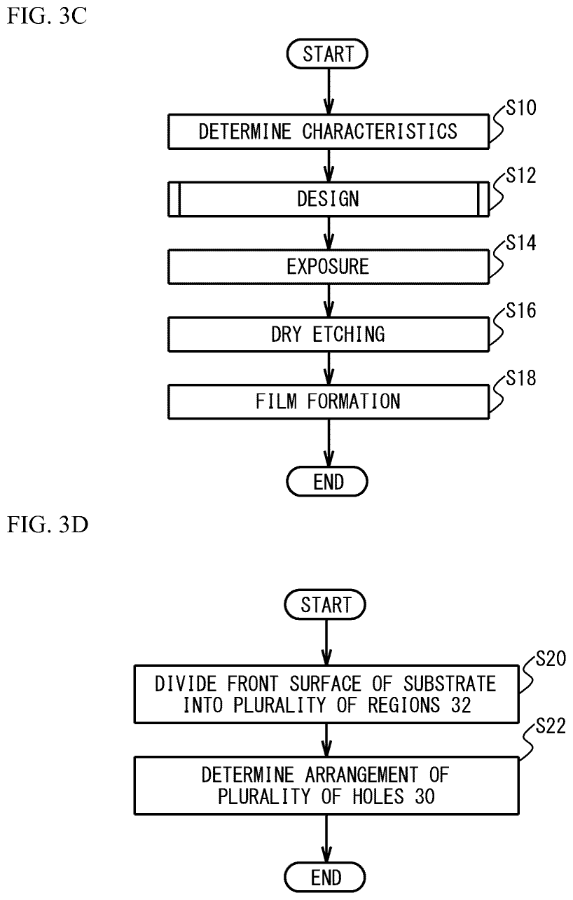

FIG. 3A is a block diagram illustrating a designing device 110 of multiplexer/demultiplexer 100. Designing device 110 designs the layout of the plurality of holes 30 in multiplexer/demultiplexer 100.

Designing device 110 includes a control unit 50. Control unit 50 is a computer or the like, and functions as a first designing unit 51 and a second designing unit 52. First designing unit 51 performs design for dividing the surface of the substrate 10 into the plurality of regions 32. Second designing unit 52 designs the positions of the plurality of holes 30 by determining region 32a and region 32b from the plurality of regions 32.

FIG. 3B is a block diagram illustrating a hardware configuration of control unit 50. As illustrated in FIG. 3B, control unit 50 includes a Central Processing Unit (CPU) 54, a Random Access Memory (RAM) 56, a Read Only Memory (ROM) 58, a storage device 60, and an interface 62. CPU 54, RAM 56, ROM 58, storage device 60, and interface 62 are connected to each other by a bus or the like. RAM 56 is a volatile memory that temporarily stores programs, data, and the like. Storage device 60 is a Solid State Drive (SSD) such as a flash memory, a Hard Disk Drive (HDD), or the like. Storage device 60 stores a program and the like.

CPU 54 executes the program stored in RAM 56, thereby enabling control unit 50 to function as first designing unit 51 and second designing unit 52. Each unit of control unit 50 may be hardware such as a circuit.

### (Manufacturing Method)

FIG. 3C and FIG. 3D are flowcharts illustrating a method of manufacturing multiplexer/demultiplexer 100. As illustrated in FIG. 3C, characteristics required for multiplexer/demultiplexer 100 are determined (step S10). The characteristics are a splitting ratio of light and the like. Further, the size of multiplexer/demultiplexer 100 is also determined. Conditions such as characteristics and element size are input to designing device 110.

Multiplexer/demultiplexer 100 is designed based on the characteristics determined in step S10 (step S12). The design is performed by performing inverse problem analysis to which machine learning is applied, with the desired characteristics as an input and the element structure as an output. Specifically, the arrangement of the plurality of holes 30 is designed by using a Bayesian direct-binary-search (Bayesian DBS).

FIG. 3D is a flowchart illustrating the processes of the design. First designing unit 51 divides the front surface of substrate 10 into the plurality of regions 32 (step S20). Regions 32 of the regular hexagonal are arranged in the close-packed structure. Second designing unit 52 determines the arrangement of the plurality of holes 30 (step S22).

As illustrated in FIG. 3C, exposure is performed on substrate 10 using techniques such as electronic beam, followed by resist patterning (step S14). Dry etching is performed on silicon layer 16 to form waveguide core 15 and the plurality of holes 30 (step S16). After the etching, cladding layer 18 is formed (step S18). The wafer is cut to form multiplexer/demultiplexer 100.

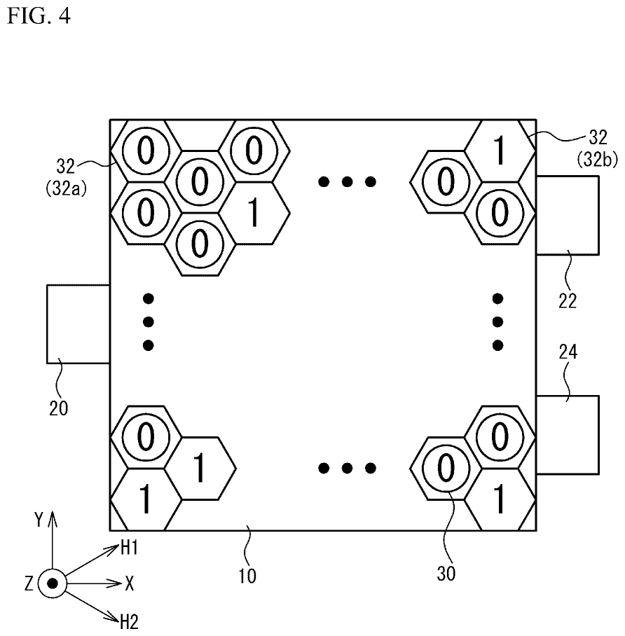

FIG. 4 is a plan view illustrating the manufacturing method of multiplexer/demultiplexer 100. In the design process (step S12 in FIG. 3C), the arrangement of holes 30 and regions 32 is determined in the surface of substrate 10 as illustrated in FIG. 4. The planar shape of region 32 is a regular hexagon. For example, 255 regions 32 are arranged in the close-packed structure on substrate 10 of 2.4 μm square.

In FIG. 4, region 32 denoted by 0 is region 32a, and hole 30 is provided. Region 32 denoted by 1 is region 32b, and hole 30 is not provided. The layout of hole 30 is determined so as to achieve the characteristics determined in the step S10.

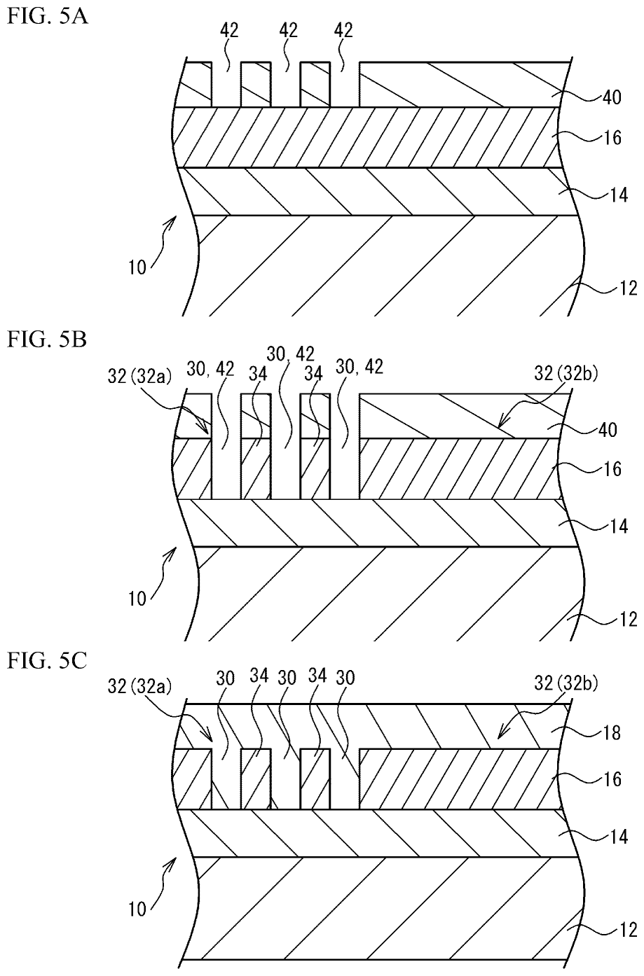

FIG. 5A to FIG. 5C are cross-sectional views illustrating a manufacturing method of multiplexer/demultiplexer 100, and illustrate a cross-section including hole 30. FIG. 5A to FIG. 5C illustrate the processes from step S14 to step S18 in FIG. 3C.

As illustrated in FIG. 5A, a resist 40 is formed on the surface of silicon layer 16 of substrate 10 opposite to BOX layer 14. Resist 40 is patterned by an electron beam or the like. An opening 42 is formed in a portion of resist 40 corresponding to hole 30. As illustrated in FIG. 5B, hole 30 is formed by removing a portion of silicon layer 16 exposed from opening 42 by, for example, Inductively Coupled Plasma-RIE (ICP-RIE). After the etching, resist 40 is removed. As illustrated in FIG. 5C, cladding layer 18 is provided, for example, by a Plasma-Enhanced Chemical Vapor Deposition (PECVD) method.

The port is also formed by the same process as that illustrated in FIG. 5A to FIG. 5C. Cladding layer 18 may be provided by removing silicon layer 16 on both sides of waveguide core 15 by ICP-RIE.

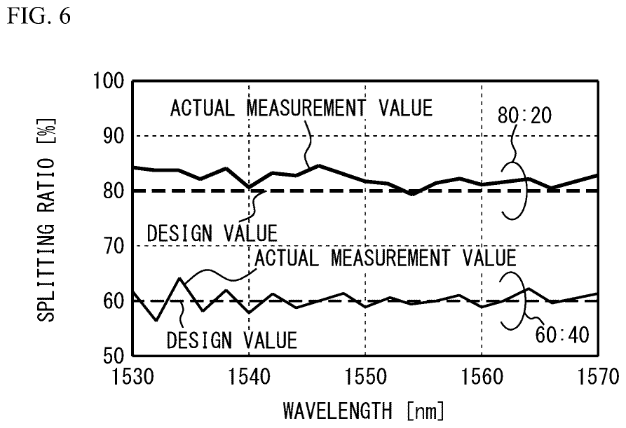

FIG. 6 is a diagram illustrating a splitting ratio. A horizontal axis represents the wavelength of light. A vertical axis represents the splitting ratio of light.

An example of a splitting ratio of 80:20 and an example of a splitting ratio of 60:40 are illustrated in FIG. 6. In each example, a dashed line represents a design value. A solid line represents an actual measurement value. Multiplexer/demultiplexer 100 is designed and manufactured with a desired splitting ratio as a design value. The splitting ratio of manufactured multiplexer/demultiplexer 100 is measured. Although the design value of the diameters of holes 30 is 120 nm, there are also holes 30 with diameters that are 140 nm due to the precision of etching and the like.

As illustrated in FIG. 6, the actual measurement values are located in the vicinity of the design values over a wavelength band wider than the C band (from 1530 nm to 1565 nm). The excess loss is about 0.5 dB. As illustrated in FIG. 3C, the desired characteristics can be achieved by designing the arrangement of holes 30 with the desired characteristics as the design value.

### COMPARATIVE EXAMPLE

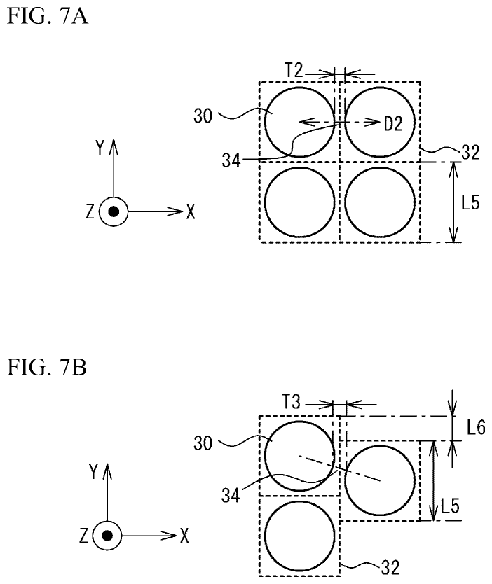

FIG. 7A is an enlarged plan view of hole 30 in the multiplexer/demultiplexer according to the comparative example. In the comparative example, region 32 is a square. The plurality of regions 32 are arranged in a square lattice, and holes 30 are also arranged in a square lattice. The square lattice arrangement means that elements are periodically arranged in the X-axis direction and the Y-axis direction. As in the embodiment, the plurality of holes 30 are arranged two dimensionally in a multiplexer/demultiplexer of 2.4 μm square.

A length L5 of region 32 is, for example, 150 nm. Hole 30 has a diameter D2 of, for example, 120 nm. A thickness T2 of wall 34 between two holes 30 is 30 nm, which is smaller than the thickness T1 of wall 34 in the first embodiment.

In the comparative example, wall 34 is thin. The wall disappears and two holes 30 are coupled in one, and thus the characteristics deteriorate. By increasing region 32, wall 34 can be thickened. However, when the size of the multiplexer/demultiplexer is limited to 2.4 μm×2.4 μm or the like, it is difficult to provide a predetermined number of holes 30, and desired characteristics may not be obtained. When the number of holes 30 is maintained and wall 34 is made thicker, the size of the multiplexer/demultiplexer is increased. By making hole 30 smaller, wall 34 can be made thicker. However, the characteristics may change as the size of hole 30 changes.

According to the first embodiment, holes 30 are formed in substrate 10 by designing so that the plurality of holes 30 adjacent to each other are arranged in the triangle lattice as illustrated in FIG. 4. As illustrated in FIG. 1A and FIG. 1B, the plurality of holes 30 are arranged in the triangle lattice on the surface of multiplexer/demultiplexer 100. Wall 34 between adjacent holes 30 is thickened. Since wall 34 is thick and is not easily broken, adjacent holes 30 are not easily coupled to each other and are separated from each other. By providing holes 30 of the designed number and layout, the desired characteristics can be obtained as illustrated in FIG. 6.

By arranging regions 32 in the triangle lattice, wall 34 can be thickened without increasing the sizes of regions 32. The number of holes 30 may not be reduced, for example, 255 holes may be maintained. The desired number and layout of holes 30 can be provided in multiplexer/demultiplexer 100 of, for example, 2.4 μm square. Multiplexer/demultiplexer 100 can be obtained which is small, for example, several m square, and has desired characteristics.

As illustrated in FIG. 4, in the design process, the surface of substrate 10 is divided into the plurality of regions 32. Region 32a in which hole 30 is provided and region 32b in which hole 30 is not provided are determined from the plurality of regions 32. By two dimensionally arranging regions 32 in the triangle lattice, holes 30 are also arranged in the triangle lattice. By manufacturing holes 30 based on the design, wall 34 is thickened and the plurality of holes 30 are separated. The desired characteristics can be obtained.

As illustrated in FIG. 1B and FIG. 4, the planar shape of region 32 is the regular hexagon, and the plurality of regions 32 are arranged in the close-packed structure. The plurality of holes 30 are arranged in a regular triangular lattice pattern. Wall 34 is thickened and the plurality of holes 30 are separated. The desired characteristics can be obtained.

As illustrated in FIG. 3C, the characteristics are first determined, and then the arrangement of the triangle lattice is designed based on the characteristics. Multiplexer/demultiplexer 100 having a triangle lattice arrangement and desired characteristics can be manufactured.

For example, hole 30 is formed in silicon layer 16 of substrate 10 by dry etching. The diameter D1 of hole 30 may be larger than the designed value due to errors in the position of the resist pattern, side etching, and so on. According to the first embodiment, since wall 34 is thick, the tolerance is improved. Adjacent holes 30 are not easily coupled to each other and are easily separated from each other. Even when an error occurs, the desired characteristics can be obtained. The thickness T1 of wall 34 is 30 nm or more, 35 nm or more, 45 nm or more, 50 nm or more, or the like.

As illustrated in FIG. 1A, substrate 10 is provided with port 20, port 22, and port 24. Light is input from port 20 and output from port 22 and port 24. Multiplexer/demultiplexer 100 functions as a power splitter that splits light into two lights. By providing the plurality of holes 30, the splitting ratio can be set to the desired value, and can be set to 80:20 or 60:40, as in the example of FIG. 6. As in the example described later, the splitting ratio may be set to a desired value.

The number of output ports is two or more, and may be three or more, or four or more. Multiplexer/demultiplexer 100 may multiplex light input from a plurality of ports. Multiplexer/demultiplexer 100 may multiplex light input from two or more ports and output multiplexed light.

The planar shape of hole 30 may be the circle, polygon, or the like. The planar shape of region 32 may be a polygon such as a hexagon, a quadrangle, or a triangle, or may be a shape including a curve such as a circle.

The multiplexer/demultiplexer may be formed on the SOI substrate or may be formed on a component other than the SOI substrate. The waveguide may include waveguide core 15 of Si or may be formed of other materials.

### (Modification)

FIG. 7B is an enlarged plan view of hole 30 in the multiplexer/demultiplexer according to the modification. Region 32 is a square. Two adjacent regions 32 are arranged so as to be shifted from the square lattice by a distance L6. When the distance L6 is 40 nm, a thickness T3 of wall 34 between two holes 30 is 35 nm, which is larger than the thickness T2 in the comparative example.

By deforming holes 30 and regions 32 from the square lattice, it is possible to arrange them in the triangle lattice. When the distance L6 is set to be half the length L5 of one side of the square lattice, the arrangement of the regular triangle lattice as illustrated in FIG. 1B can be obtained.

### Second Embodiment

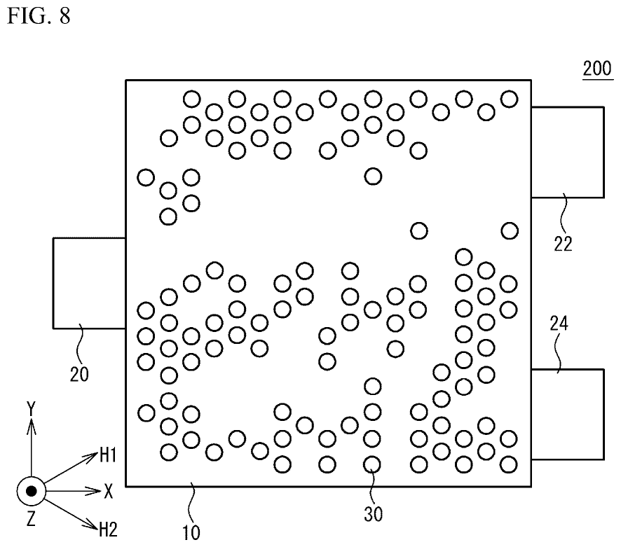

FIG. 8 is a plan view illustrating a multiplexer/demultiplexer 200 according to a second embodiment. The description of the same configuration as that of the first embodiment will be omitted. In the second embodiment, the splitting ratio of the light intensity is set to 90:10. The process of FIG. 3C is performed with a splitting ratio of 90:10 as the desired characteristics. The arrangement of holes 30 is determined according to the splitting ratio, and holes 30 as illustrated in FIG. 8 are formed.

Multiplexer/demultiplexer 200 splits the light input from port 20 into two lights and outputs the two lights. The ratio between the intensity of the light output from port 22 and the intensity of the light output from port 24 is 90:10.

### Third Embodiment

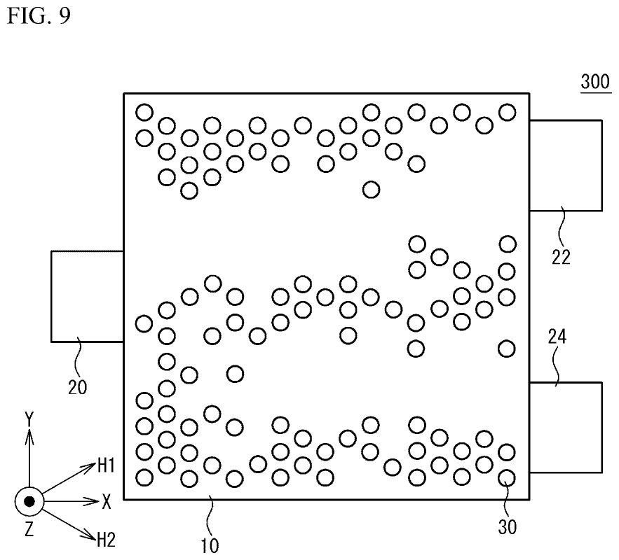

FIG. 9 is a plan view illustrating a multiplexer/demultiplexer 300 according to a third embodiment. The description of the same configuration as that of the first embodiment or the second embodiment will be omitted. In the third embodiment, the splitting ratio of light is set to 70:30. The ratio between the intensity of the light output from port 22 and the intensity of the light output from port 24 is 70:30.

### Fourth Embodiment

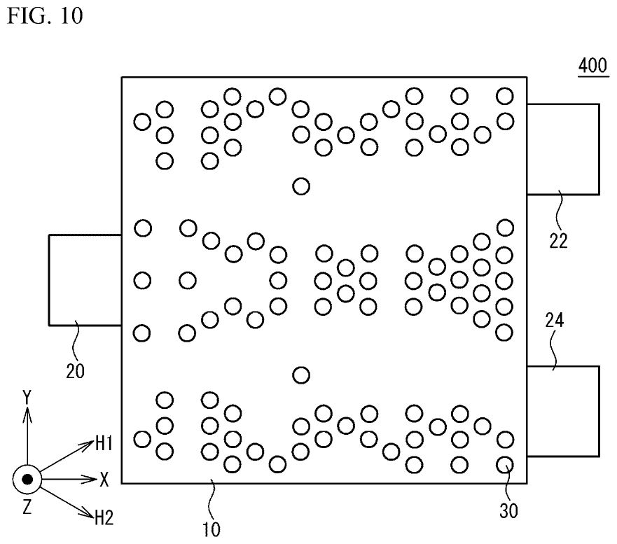

FIG. 10 is a plan view illustrating a multiplexer/demultiplexer 400 according to a fourth embodiment. The description of the same configuration as that of any one of the first embodiment to the third embodiment will be omitted. In the fourth embodiment, the splitting ratio of light is 50:50. The ratio between the intensity of the light output from port 22 and the intensity of the light output from port 24 is 50:50.

As illustrated in FIG. 8 and FIG. 9, more holes 30 are provided between port 20 and port 24 than between port 20 and port 22. That is, more holes 30 are arranged near port 24 having a lower output than near port 22 having a higher output of the two ports. As illustrated in FIG. 10, in the example of the splitting ratio of 50:50, the arrangement of holes 30 is symmetrical with respect to the X-axis.

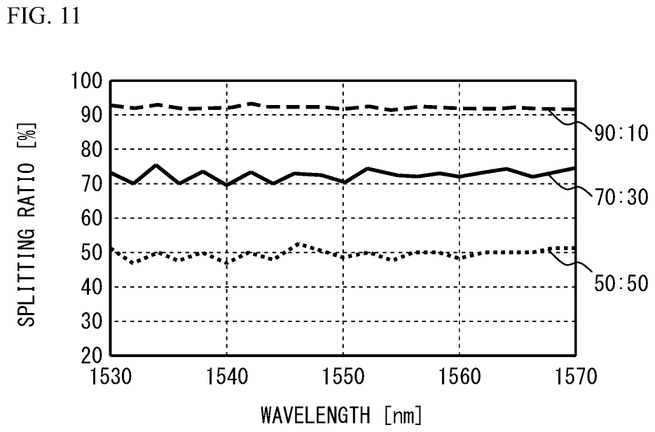

FIG. 11 is a diagram illustrating a splitting ratio. A dashed line represents an example in which the splitting ratio is 90:10 (second embodiment). A solid line represents the example in which the splitting ratio is 70:30 (third embodiment). A dotted line represents the example in which the splitting ratio is 50:50 (fourth embodiment). In each example, the splitting ratio is substantially equal to the design value. By designing the arrangement of holes 30 based on the desired splitting ratio, a multiplexer/demultiplexer corresponding to the splitting ratio can be manufactured. The excess loss is about 0.5 dB. Since the destruction of wall 34 is suppressed and the plurality of holes 30 are separated, the loss of light is reduced.

### Fifth Embodiment

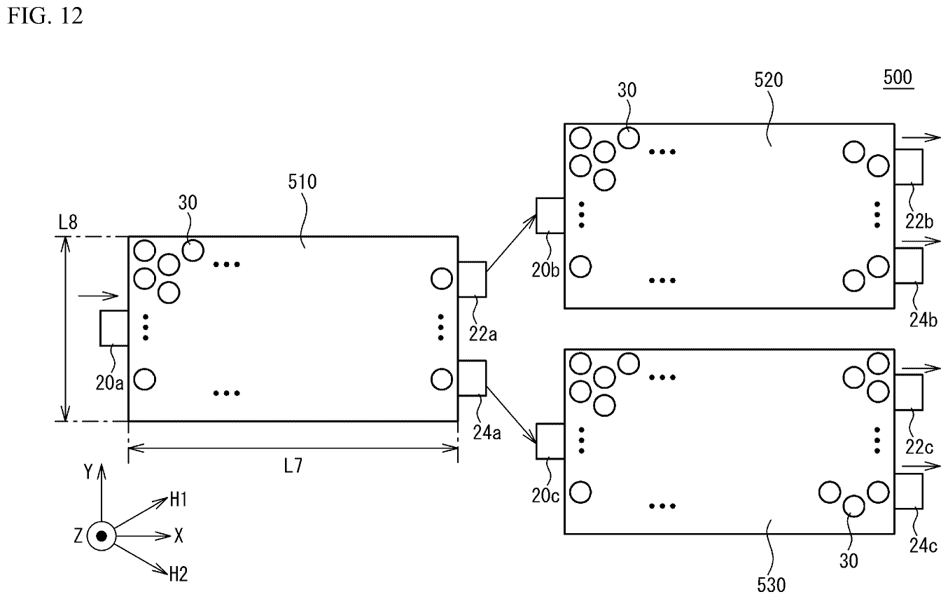

FIG. 12 is a plan view illustrating a demultiplexer 500 according to a fifth embodiment. The description of the same configuration as that of any one of the first embodiment to the fourth embodiment will be omitted.

Demultiplexer 500 includes three multiplexer/demultiplexers which are a multiplexer/demultiplexer 510, a multiplexer/demultiplexer 520 and a multiplexer/demultiplexer 530. For example, a length L7 of one multiplexer/demultiplexer in the X-axis direction is 17.2 μm. A length L8 in the Y-axis direction is 7.5 μm. Multiplexer/demultiplexer 510 (first multiplexer/demultiplexer) has a port 20a, a port 22a, and a port 24a. Multiplexer/demultiplexer 520 (second multiplexer/demultiplexer) has a port 20b, a port 22b, and a port 24b. Multiplexer/demultiplexer 530 (third multiplexer/demultiplexer) has a port 20c, a port 22c, and a port 24c.

Port 22a of multiplexer/demultiplexer 510 is optically coupled to port 20b of multiplexer/demultiplexer 520. Port 24a of multiplexer/demultiplexer 510 is optically coupled to port 20c of multiplexer/demultiplexer 530. The ports may be coupled by, for example, a silicon waveguide or may be coupled by a transmission path such as an optical fiber.

Each of the three multiplexer/demultiplexers has the plurality of holes 30. The diameter of hole 30 is 160 nm. The distance between the centers of two holes 30 is 250 nm. In each multiplexer/demultiplexer, the plurality of holes 30 are arranged in the triangle lattice. The layout of hole 30 is determined according to the characteristics required for the multiplexer/demultiplexer. The three multiplexers/demultiplexers splits light into two lights for each wavelength. Demultiplexer 500 is a one-input-and-four-output device, and splits light into four lights for each wavelength.

Multiplexer/demultiplexer 510 splits the light input from port 20a into two lights according to the wavelength and outputs the split light. The light having the wavelength 1590 nm and the light having the wavelength 1570 nm are output from port 22a and input to multiplexer/demultiplexer 520 from port 20b. The light having the wavelength 1550 nm and the light having the wavelength 1530 nm are output from port 24a and input to multiplexer/demultiplexer 530 from port 20c.

Multiplexer/demultiplexer 520 emits light having a wavelength of 1590 nm from port 22b and emits light having a wavelength of 1570 nm from port 24b. Multiplexer/demultiplexer 530 emits light having a wavelength of 1550 nm from port 22c and emits light having a wavelength of 1530 nm from port 24c.

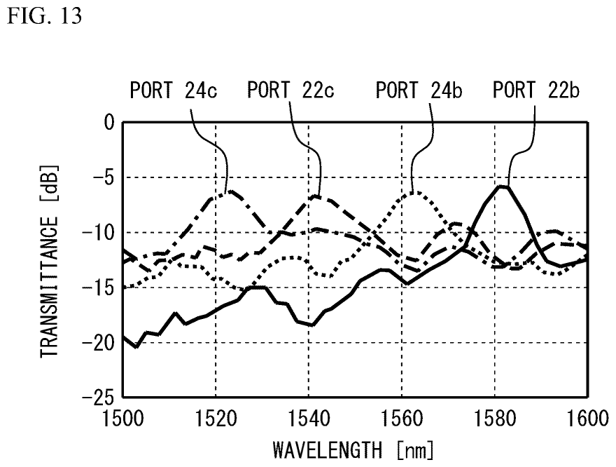

FIG. 13 is a diagram illustrating transmittance. A horizontal axis represents the wavelength of light. A vertical axis represents transmittance. The ratio of the intensity of light output from each port to the intensity of light input to port 20a of demultiplexer 500 is measured. A one dot chain line in FIG. 13 represents the transmittance of port 24c. A dashed line represents the transmittance of port 22c. A dotted line represents the transmittance of port 24b. A solid line represents the transmittance of port 22b.

The transmittance of port 24c has a peak near 1525 nm. The transmittance of port 22c has a peak near 1545 nm. The transmittance of port 24b has a peak near 1565 nm. The transmittance of port 22b has a peak near 1585 nm. The insertion loss of entire demultiplexer 500 is about 7 dB. The extinction ratio is 3 dB or more.

According to the fifth embodiment, port 22a of multiplexer/demultiplexer 510 of multiplexer/demultiplexer 510 is coupled to port 20b of multiplexer/demultiplexer 520. Port 24a of multiplexer/demultiplexer 510 is coupled to port 20c of multiplexer/demultiplexer 530. Multiplexer/demultiplexer 520 splits the light input to port 20b into two lights and outputs the split lights from port 22b and port 24b. Multiplexer/demultiplexer 530 splits the light input to port 20c into two lights and outputs the split lights from port 22c and port 24c. Demultiplexer 500 splits the light into four lights according to the wavelength. In the three multiplexers/demultiplexers, the plurality of holes 30 are arranged in the triangle lattice. Wall 34 becomes thick, and adjacent holes 30 are hardly coupled to each other. The deterioration of the characteristics of each multiplexer/demultiplexer can be suppressed, and the desired characteristics can be obtained in demultiplexer 500.

Three or more multiplexers/demultiplexers may be connected to form a demultiplexer. For example, four multiplexers/demultiplexers are coupled to output ports of a multiplexer/demultiplexer having one-input-and-four-output. Each of the four multiplexers/demultiplexers splits light into two lights. A demultiplexer splits light into eight lights according to the wavelength.

The functions described above with respect to the design can be implemented by a computer. In this case, a program describing the processing contents of the functions that a processing apparatus should have is provided. The program is executed by the computer, and thus the processing functions are achieved on the computer. The program describing the processing contents may be recorded in a non-transitory computer-readable storage medium (excluding a carrier wave).

When the program is distributed, for example, the program is sold in a form of a portable storage medium such as a Digital Versatile Disc (DVD) or a Compact Disc Read Only Memory (CD-ROM) in which the program is recorded. Furthermore, it is possible to store the program in the memory storage of a server computer and the program may be transferred from the server computer to another computer via a network.

The computer executing the program stores, for example, the program recorded in the portable storage medium or the program transferred from the server computer in its own storage device. The computer reads the program from the storage device of the computer and executes processing according to the program. It is noted that, the computer can read the program directly from the portable storage medium and execute the processing according to the program. Further, the computer can also execute processing according to the received program each time the program is transferred from the server computer.

Although the embodiments of the present disclosure have been described in detail, the present disclosure is not limited to the specific embodiments, and various modifications and changes can be made within the scope of the gist of the present disclosure described in the claims.

What is claimed is:

1. A method of manufacturing a multiplexer/demultiplexer including a substrate, a first port for inputting light, and a second port for outputting light, the first port and the second port being provided in the substrate, the method comprising:
designing positions of a plurality of holes such that three adjacent holes among the plurality of holes are arranged in a triangle lattice; and
forming the plurality of holes in a surface of the substrate.

2. The method of manufacturing the multiplexer/demultiplexer according to claim 1, wherein the designing includes dividing the surface of the substrate into a plurality of regions arranged in the triangle lattice, and arranging the holes in some of the plurality of regions, respectively and arranging no holes in the others of the plurality of regions.

3. The method of manufacturing the multiplexer/demultiplexer according to claim 2, wherein
the regions have a regular hexagonal planar shape, and
the dividing the surface of the substrate into the plurality of regions includes arranging the plurality of regions in a close-packed structure.

4. The method of manufacturing the multiplexer/demultiplexer according to claim 1, wherein the designing is designing the positions of the plurality of holes on the basis of characteristics of the multiplexer/demultiplexer.

5. The method of manufacturing the multiplexer/demultiplexer according to claim 1, wherein the forming the plurality of holes includes forming the plurality of holes by performing dry etching on a silicon layer in the substrate.

6. The method of manufacturing the multiplexer/demultiplexer according to claim 1, further comprising:
forming a cladding layer on the surface of the substrate after forming the plurality of holes.

7. The method of manufacturing the multiplexer/demultiplexer according to claim 4, wherein
the multiplexer/demultiplexer includes a plurality of second ports for outputting light, and
the characteristics of the multiplexer/demultiplexer include a splitting ratio of light to the plurality of second ports.

8. A multiplexer/demultiplexer comprising:
a substrate; and
a first port and a second port provided in the substrate, wherein
light is input to the first port and output from the second port,
a plurality of holes are provided in a surface of the substrate, and
three adjacent holes among the plurality of holes are arranged in a triangle lattice.

9. The multiplexer/demultiplexer according to claim 8, wherein
the substrate includes a silicon layer, and
the plurality of holes are provided in a surface of the silicon layer.

10. The multiplexer/demultiplexer according to claim 8, wherein the three adjacent holes are arranged in a regular triangle shape.

11. The multiplexer/demultiplexer according to claim 8, wherein the first port includes a single port and the second port includes a plurality of ports.

12. The multiplexer/demultiplexer according to claim 8, further comprising:
a cladding layer provided on the surface of the substrate.

13. The multiplexer/demultiplexer according to claim 8, wherein
the substrate includes a wall between adjacent ones of the plurality of holes, and
a thickness of the wall is 30 nm or more.

14. The multiplexer/demultiplexer according to claim 9, wherein
the substrate includes the silicon layer and a box layer, and
the box layer is provided on another surface of the silicon layer opposite to the surface of the silicon layer.

15. A demultiplexer comprising:
a first multiplexer/demultiplexer;
a second multiplexer/demultiplexer; and
a third multiplexer/demultiplexer, wherein
each of the first multiplexer/demultiplexer, the second multiplexer/demultiplexer, and the third multiplexer/demultiplexer includes:
a substrate; and
a first port and at least one second port provided in the substrate, wherein
a plurality of holes are provided in a surface of the substrate, and
three adjacent holes among the plurality of holes are arranged in a triangle lattice, the at least one second port of the first multiplexer/demultiplexer includes two second ports,
one of the two second ports of the first multiplexer/demultiplexer is coupled to the first port of the second multiplexer/demultiplexer, and
the other of the two second ports of the first multiplexer/demultiplexer is coupled to the first port of the third multiplexer/demultiplexer.

16. The demultiplexer according to claim 15, wherein
the substrate of each of the first multiplexer/demultiplexer, the second multiplexer/demultiplexer, and the third multiplexer/demultiplexer includes a silicon layer, and
the plurality of holes are provided in a surface of the silicon layer.

17. The demultiplexer according to claim 15, wherein
in each of the first multiplexer/demultiplexer, the second multiplexer/demultiplexer, and the third multiplexer/demultiplexer, the three adjacent holes are arranged in a regular triangle shape.

18. A designing device for a multiplexer/demultiplexer including a substrate, a first port for inputting light, a second port for outputting light, and a plurality of holes provided in a surface of the substrate, the first port and the second port being provided in the substrate, the designing device comprising:
a controller that designs positions of the plurality of holes such that three adjacent holes among the plurality of holes are arranged in a triangle lattice in the surface of the substrate.

19. The designing device for the multiplexer/demultiplexer according to claim 18, wherein
the controller includes a first design unit that performs design for dividing the surface of the substrate into a plurality of regions arranged in the triangle lattice, and a second design unit that performs design for arranging the holes in some of the plurality of regions, respectively, and arranging no holes in the others of the plurality of regions.

20. The designing device for the multiplexer/demultiplexer according to claim 19, wherein
the regions have a regular hexagonal planar shape, and
the first design unit arranges the plurality of regions in a close-packed structure on the surface of the substrate.

21. The designing device for the multiplexer/demultiplexer according to claim 18, wherein
the controller designs the positions of the plurality of holes on the basis of characteristics of the multiplexer/demultiplexer.

22. A non-transitory computer-readable recording medium having stored therein a designing program for a multiplexer/demultiplexer for causing a computer to execute a process, the multiplexer/demultiplexer including a substrate, a first port for inputting light, a second port for outputting light, and a plurality of holes provided in a surface of the substrate, the first port and the second port being provided in the substrate, the process comprising:
designing positions of the plurality of holes such that three adjacent holes among the plurality of holes are arranged in a triangle lattice in the surface of the substrate.

23. The non-transitory computer-readable recording medium according to claim 22, wherein
the designing positions of the plurality of holes includes performing design for dividing the surface of the substrate into a plurality of regions arranged in the triangle lattice, and performing design for arranging the holes in some of the plurality of regions, respectively, and arranging no holes in the others of the plurality of regions.

24. The non-transitory computer-readable recording medium according to claim 23, wherein
the regions have a regular hexagonal planar shape, and
the plurality of regions are arranged in a close-packed structure on the surface of the substrate.

25. The non-transitory computer-readable recording medium according to claim 22, wherein
the designing positions of the plurality of holes is performed on the basis of characteristics of the multiplexer/demultiplexer.
